(19) United States
(12) Patent Application Publication
(10) Pub. No.: US 2026/0245758 A1
(43) Pub. Date: Aug. 20, 2026

(54) ROLLING RADIOPROTECTIVE SCREEN

(71) Applicant: LEMER PAX, LA CHAPELLE SUR ERDRE (FR)

(72) Inventor: Pierre-Marie LEMER, NANTES (FR)

(21) Appl. No.: 19/164,481

(22) PCT Filed: Mar. 12, 2024
(86) PCT No.: PCT/EP2024/056588

§ 371 Date: Sep. 11, 2025

(30) Foreign Application Priority Data
Mar. 15, 2023 (FR) FR2302401

(51) Int. Cl. G21F 3/00

(52) U.S. Cl. CPC G21F 3/00

(57) ABSTRACT

The present invention relates to a screen (1) made of a radioprotective material for protecting an operator from X-rays or other types of ionising radiation emissions. This screen (1) comprises two free lateral sides (2″, 3″) and rests on the ground via a base (6) provided with castors (7, 8). At least two front castors (7) extend in a cantilevered manner from the front face of the screen (1b), and two other lateral castors (8) are each mounted at the end of a support device (9) arranged on one of the free lateral sides (2″, 3″). According to the invention, the support device (9) for the lateral castors (8) comprises at least one horizontal connecting rod (10, 11), provided with two vertical pivot axes (12, 14, 15), for pivotably mounting the lateral castors (8) about at least two vertical axes.

### TECHNICAL FIELD OF THE INVENTION

The present invention relates to the general field of equipment for protection against ionizing radiation.

It concerns more particularly radioprotective screens which are used in medical or other environments, to protect an operator against emissions of ionizing radiation, for example X-rays, and even more particularly rolling radioprotective screens, that is to say screens which rest on the ground by means of casters to facilitate their movement.

### STATE OF THE ART

Radioprotective screens are known, in particular from document FR-3 106 273, which comprise a front wall extended by a side wall on one of its sides, or on both sides, and which rest on the ground by means of casters.

For example, two casters are mounted at the end of a support member which extends cantilevered from the front side of the screen (opposite the positioning of the operator); and two other casters are mounted at the end of a support device arranged at the free lateral sides of the screen.

However, to ensure effective protection against ionizing radiation, these screens are made from very dense materials. Their weight is therefore generally high (in the order of several hundred kilograms), and, even when they include a rolling base, they are generally quite difficult to move.

In particular, the corresponding movement maneuvers may be blocked or may be subject to jolts, particularly in the case where one of the casters is not aligned with the thrust axis on the screen.

### PRESENTATION OF THE INVENTION

In order to overcome the aforementioned drawback of the state of the art, the present invention proposes a screen made of radioprotective material to ensure the protection of an operator against emissions of ionizing radiation of the X-ray type or of other types,
which screen comprises a front wall delimited by two lateral sides, at least one of said lateral sides extending by a side wall,
which screen comprises two free lateral sides, a rear screen face opposite which said operator is intended to position himself and a front screen face opposite said rear screen face,
and which screen rests on the ground by means of a base fitted with casters, each one of at least two ones of said casters, called “front casters”, being mounted at the end of a support member extending cantilevered from the side of said front face of the screen,
and each one of two other ones of said casters, called “side casters”, being mounted at the end of a support device arranged at one of said free lateral sides,
this screen being characterized by the fact that said support device for said side casters comprises at least one horizontal connecting rod provided with two vertical pivot axes, for the pivoting mounting of said side casters around at least two vertical axes.

The push to initiate the movement of the screen requires little effort, and the movement of the screen is then carried out very regularly, limiting jolts and blockages, in particular in the case of a push parallel to the axis of rotation of one of the casters.

Other non-limiting and advantageous characteristics of the screen according to the invention, taken individually or in all technically possible combinations, are the following ones:

According to one embodiment, the support device for the side rollers may comprise two horizontal connecting rods articulated together around a vertical pivot axis, for the pivoting mounting of said side rollers around three vertical axes.

In this case, the support device may include:
an upper connecting rod provided with (a) an upper connecting rod upper face, (b) an upper connecting rod lower face, (c) a first upper connecting rod cylindrical orifice partially closed on the side of said upper face by an upper support ring, and (d) a second upper connecting rod cylindrical orifice partially closed at the bottom by a lower support ring,
a lower connecting rod provided with (a) a lower connecting rod upper face, (b) a lower connecting rod lower face, (c) a lower connecting rod journal, which extends upwardly from said lower connecting rod upper face, and (d) a caster axle housing, which opens into said lower connecting rod lower face,
an upper end piece comprising a lower journal and an upper journal separated by an upper end piece crown, which lower journal is intended to penetrate into said first cylindrical orifice of the upper connecting rod, with a first rolling structure being interposed between the top of said upper bearing crown and the bottom of said upper end piece crown, a second rolling structure being arranged in said first cylindrical orifice of the upper connecting rod, bearing on the bottom of said upper bearing crown, and locking means being provided on the side of the lower face of the upper connecting rod to assemble said upper end piece with said upper connecting rod,
said upper journal being intended to enter a complementary receiving housing provided at the end of a support leg secured to one of said free lateral sides of the screen,
said lower connecting rod journal being intended to enter said second cylindrical orifice of the upper connecting rod, with a third bearing structure being interposed between the underside of said lower bearing ring and the upper face of the lower connecting rod, a fourth bearing structure being arranged in said second cylindrical orifice of the upper connecting rod, bearing on the top of said lower bearing ring, and removable locking means being provided on the side of the upper face of the upper connecting rod to assemble said lower connecting rod journal with said upper connecting rod,
said caster axle housing of said lower connecting rod being intended to receive a caster journal secured to the associated caster.

Still according to the invention, the two axes of the connecting rod or rods of the support device can be spaced apart by a distance of between 30 and 100 mm.

In a particular embodiment of the support device, of the two-connecting rod type, the two axes of an upper connecting rod can be spaced apart by a distance of between 50 and 80 mm, and the two axes of a lower connecting rod can be spaced apart by a distance of between 30 and 50 mm.

According to another feature, said support device comprises a support leg which is fixed to one of the free lateral sides of the screen by means of fixing screws. Preferably, this support leg extends in the plane of the wall of the screen which it extends.

On the other hand, the side casters are equipped with removable locking means adapted to ensure that they are held in a specific orientation.

Of course, the various features, variants and embodiments of the invention may be combined with each other in various combinations to the extent that they are not incompatible or mutually exclusive.

### DETAILED DESCRIPTION OF THE INVENTION

In addition, various other characteristics of the invention emerge from the appended description given with reference to the drawings which illustrate non-limiting embodiments of the invention and where:

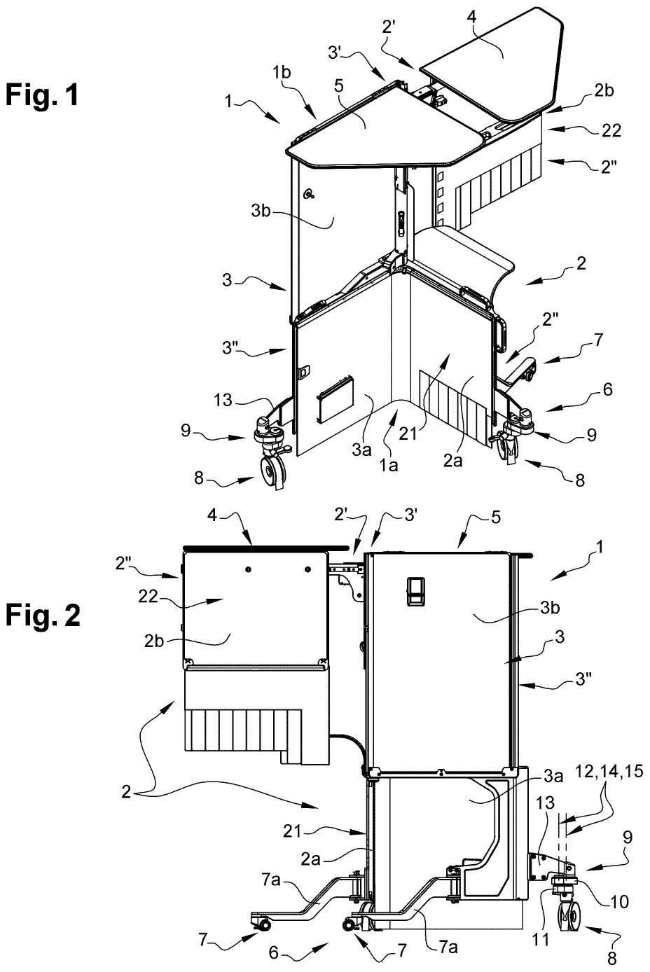

FIG. 1 is a perspective view of a rolling radioprotective screen in accordance with the present invention;

FIG. 2 is a side view of the radioprotective screen of FIG. 1;

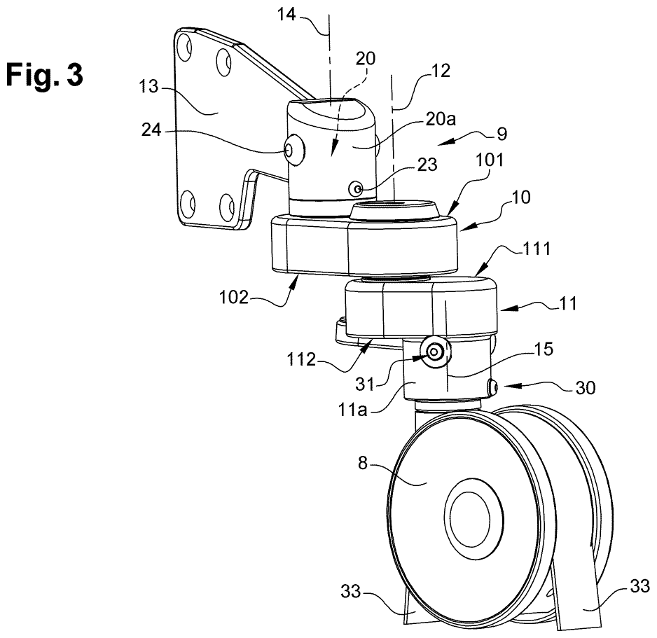

FIG. 3 is an enlarged view of one of the side casters of the radioprotective screen illustrated in FIGS. 1 and 2, with its support device;

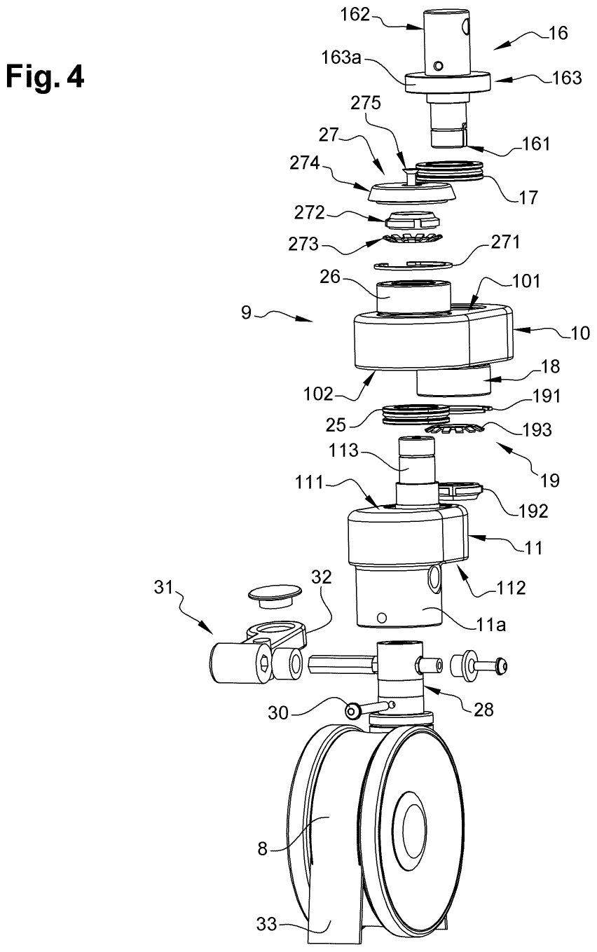

FIG. 4 is an exploded view of the side caster support device illustrated in FIG. 3;

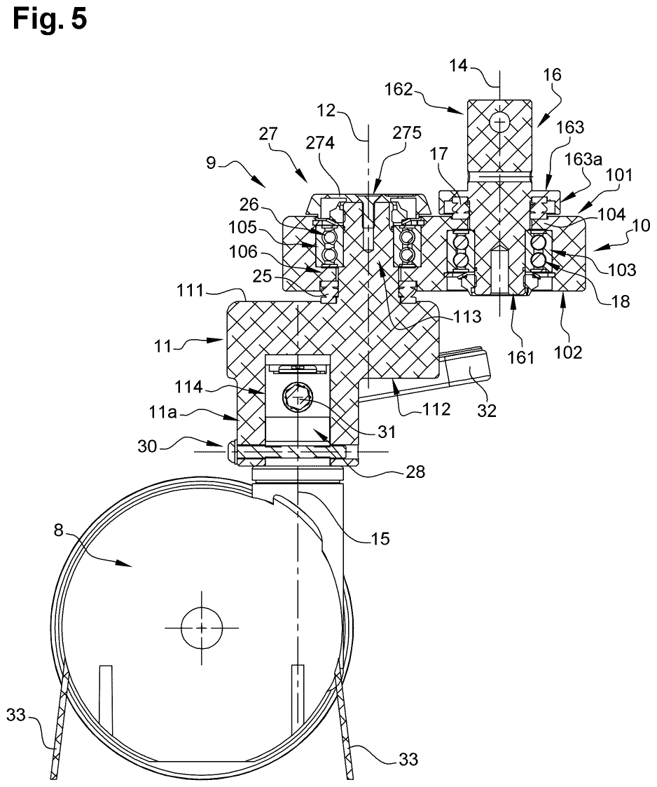

FIG. 5 is a vertical sectional view of the side caster support device illustrated in FIGS. 3 and 4.

The radioprotective screen 1, shown in FIGS. 1 and 2, is intended to protect an operator against emissions of ionizing radiation.

This radioprotective screen 1 comprises a front wall 2 delimited by two lateral sides 2′, 2″, one of which 2′ is extended by a side wall 3, and the other 2″ of which constitutes a free lateral side.

The side wall 3 is delimited by two lateral sides 3′, 3″, one of which 3′ is extended by the front wall 2, and the other 3″ constitutes a free lateral side.

The lower part 21 of the front wall 2 is fixed relative to the side wall 3 and arranged at right angles, or at substantially right angles, to the latter.

The upper part 22 of the front wall 2 is movable and pivotally mounted around a vertical axis on one of the sides of the side wall 3.

The upper edge of the upper part 22 of the front wall 2, and the upper edge of the side wall 3 are extended by an additional wall, respectively 4 and 5, acting as a ceiling. These two additional walls 4 and 5 are arranged at slightly different height levels to allow their superposition during the pivoting maneuvers of the upper part 22 of the front wall 2.

Walls 2 and 3 are made of panels made of suitable radioprotective material, combined and supported by a metal frame ensuring continuity of radioprotection at the level of all junctions.

The front wall 2 and the side wall 3 each comprise in particular—an opaque lower panel 2a, 3a (for example made of wooden panel(s) shielded with lead sheets), and—a transparent upper panel 2b, 3b (for example made of lead glass, or other transparent radioprotective material) to provide frontal and lateral visibility to the operator who is working in particular in a medical environment.

This radioprotective screen 1 comprises two free lateral sides 2″ and 3″, a rear screen face 1a opposite which the operator is intended to position himself and a front screen face 1b, opposite said rear screen face 1a.

The radioprotective screen 1 rests on the ground by means of a base 6 equipped with casters 7, 8, which allow its stability and also its easy movement on the ground by simple rolling.

Two casters 7, called “front” casters 7, are each mounted at the end of a support member 7a, in the form of a console or strut, which extends from the lower panels 2a, 3a, cantilevered therefrom, and towards the front (i.e. on the side of the front face 1b of the screen).

These two front casters 7 have the particular advantage of increasing the surface area of the support perimeter of the screen 1 in front of it, and they contribute to optimizing its stability.

Two other casters 8, called “side casters” 8, are mounted at the end of a support device 9 arranged at the level of the two free lateral sides 2″, 3″ of the screen 1.

Here again, these two side casters 8 have the advantage of increasing the surface area of the support perimeter of the screen 1 on the sides of the latter, and they contribute to optimizing its stability.

The support device 9 for these side casters 8 is shown separately from the screen in FIGS. 3, 4 and 5.

According to the invention, this support device 9 for the side casters 8 comprises at least one horizontal connecting rod provided with two vertical pivot axes, for the pivoting mounting of said side casters around at least two vertical axes; and preferably it comprises two horizontal connecting rods articulated together around a vertical pivot axis, for the pivoting mounting of said side casters around three vertical axes.

Such features make it easier to move the radioprotective screen on the ground, taking into account its generally significant weight, in the order of several hundred kilograms (for example 100 to 350 kg).

The initial push to move the screen requires little effort; and then, the screen moves very smoothly, limiting jolts and blockages, especially when pushing parallel to the rotation axis of one of the casters. The screen can also be moved a little while the side casters remain fixed.

As can be seen in FIGS. 3 to 5, the support device 9 here comprises an upper connecting rod 10 and a lower connecting rod 11 articulated together around a first vertical axis 12. The upper connecting rod 10 is articulated at the end of a support tab 13 secured to one of the free lateral sides 2″, 3″ of the screen 1, around a second vertical axis 14 which is offset relative to the first axis 12. In addition, the lower connecting rod 11 and the caster 8 are articulated together around a third vertical axis 15 which is offset relative to the first vertical axis 12.

Generally speaking, the two axes of the connecting rods 10, 11 are advantageously spaced apart by a distance of between 30 and 100 mm.

In a particular embodiment, the two axes 12 and 14 of the upper connecting rod 10 are spaced apart by a distance of between 50 and 80 mm, and the two axes 12 and 15 of the lower connecting rod 11 are spaced apart by a distance of between 30 and 50 mm.

The various joints 12, 14 and 15 are equipped with bearing structures to optimize the pivoting capacities of the connecting rods 10, 11 and the associated caster 8.

According to an interesting embodiment, the upper connecting rod 10 is provided with:
an upper connecting rod upper face 101,
an upper connecting rod lower face 102,
a first cylindrical upper connecting rod orifice 103 partially closed on the side of said upper connecting rod upper face 101 by an upper support ring 104, and
a second cylindrical upper connecting rod orifice 105 partially closed in the lower part by a lower support ring 106.

For its part, the lower connecting rod 11 includes:
a lower connecting rod upper face 111,
a lower connecting rod lower face 112,
a lower connecting rod pin 113, which extends upwardly from said lower connecting rod upper face 111, and
a caster axle housing 114, which opens into said lower connecting rod lower face 112.

In the illustrated embodiment, the caster axle housing 114 is primarily provided in a sleeve 11a constituting a one-piece extension of the lower connecting rod lower face 112.

The support device 9 also comprises an upper end piece 16 comprising a lower journal 161 and an upper journal 162 separated by an upper end piece ring 163.

The lower journal 161 is intended to penetrate into the first cylindrical upper connecting rod orifice 103, with the interposition of a first bearing structure 17 between the top of said upper support ring 104 and the bottom of said upper end piece ring 163.

This first bearing structure 17 may be of the ball thrust bearing type.

It is noted that the upper end cap ring 163 has a circular peripheral skirt 163a which allows the integration and masking of the rolling structure 17.

A second bearing structure 18 is arranged in the first cylindrical upper connecting rod orifice 103, bearing on the underside of the upper support ring 104.

Removable locking means 19 are provided on the side of the upper connecting rod lower face 102 for assembling the upper end piece 16 with the upper connecting rod 10. These removable locking means 19 are constituted, (a) by an open elastic ring 191 intended to be positioned in a complementary circular groove formed in the first cylindrical upper connecting rod orifice 103, to hold the second bearing structure 18, and (b) by a self-locking nut with notches 192, adapted to be screwed onto a complementary thread formed at the end of the lower connecting rod journal 113, with the interposition of a washer for a notched nut 193.

The second bearing structure 18 may be of the double-row ball bearing and angular contact type.

The upper pin 162 of the upper end piece 16 is intended to enter a complementary receiving housing 20 provided at the end of the support tab 13 secured to one of said free lateral sides 2″, 3″ of the screen 1.

This receiving housing 20 is delimited by a sleeve 20a open at the bottom. The upper journal 162 is immobilized in the receiving housing 20 by means of screws 23, 24 passing through appropriate orifices made in the sleeve 20a and in the upper journal 162.

The lower connecting rod journal 113 enters the second cylindrical upper connecting rod orifice 105, with the interposition of a third bearing structure 25 between the underside of the lower support ring 106 and the lower connecting rod upper face 111.

This third bearing structure 25 may be of the thrust ball bearing type.

A fourth bearing structure 26 is arranged in the second cylindrical upper connecting rod orifice 105, bearing on the top of the lower support ring 106. This fourth bearing structure 26 may be of the double-row ball bearing and angular contact type.

Removable locking means 27 are provided on the side of the upper connecting rod upper face 101 for assembling the lower connecting rod journal 113 with said upper connecting rod 10. These removable locking means 27 are constituted, (a) by an open elastic ring 271 intended to be positioned in a complementary circular groove formed in the second cylindrical upper connecting rod orifice 105, to hold the fourth bearing structure 26, and (b) by a self-locking nut with notches 272, adapted to be screwed onto a complementary thread formed at the end of the lower journal 161 of the upper end piece 16, with the interposition of a washer for a notched nut 273.

A protective cover 274 covers the removable locking means 27. This protective cover 274 is fixed to the upper end of the lower connecting rod journal 113 by means of an axial screw 275.

The caster axle housing 114 defined by the sleeve 11a of the lower connecting rod 11 is intended to receive a caster journal 28 secured to the associated caster 8.

The caster 8 with its caster journal 28, of known structure, has the capacity to pivot around the aforementioned third vertical axis 15.

A swivel castor with central locking (for example a “Linea” model from the company TENTE SAS—St Fargeau Ponthierry—France) can be used.

The caster journal 28 is immobilized in its receiving housing 114 by means of a screw 30. And removable locking means 31 are adapted to ensure that the associated caster 8 is maintained in a determined orientation (without the possibility of pivoting).

These removable locking means 31 are conventional and well known in themselves. They include a control pedal 32 for activation/deactivation maneuvers by foot.

In FIGS. 3 to 5 in particular, we note that the side rollers 8 are equipped with conventional cable pushing systems 33, to avoid or at least limit the possibility of the screen rolling on a cable on the ground.

The support tab 13 is fixed to one of the free lateral sides 2″, 3″ of the screen 1 by means of fixing screws (either directly or via a dedicated support structure). This support tab 13 (and/or the dedicated support structure) preferably extends in the plane of the wall (2a, 3a) which it extends.

In an alternative embodiment, the support device 9 may comprise a single horizontal connecting rod, for the pivoting mounting of the side casters 8 around two vertical axes.

Of course, other types of radiation protection screens can be equipped with side rollers mounted on a support device in accordance with the invention.

1. Screen made of radioprotective material to ensure the protection of an operator against emissions of ionizing radiation such as X-rays or others,
which screen comprises a front wall delimited by two lateral sides, at least one of said lateral sides extending by a lateral wall,
which screen comprises two free lateral sides, a rear screen face opposite which said operator is intended to position himself and a front screen face opposite said rear screen face,
and which screen rests on the ground by means of a base fitted with casters,
each one of at least two ones of said casters, called “front casters” being mounted at the end of a support member extending cantilevered on the side of said front face of the screen,
and each one of two other ones of said casters, called “side casters”, being mounted at the end of a support device arranged at one of said free lateral sides,
wherein said support device of said lateral casters comprises at least one horizontal connecting rod, provided with two vertical pivot axes, for the pivoting mounting of said lateral casters around at least two vertical axes

2. Screen made of radioprotective material according to claim 1, wherein said support device of said lateral casters comprises two horizontal connecting rods articulated together around a vertical pivot axis, for the pivoting mounting of said lateral casters around three vertical axes.

3. Screen made of radioprotective material according to claim 2, wherein said support device comprises:
an upper connecting rod provided with (a) an upper connecting rod upper face (b) an upper connecting rod lower face, (c) a first cylindrical upper connecting rod orifice partially closed on the side of said upper connecting rod upper face by an upper support ring, and (d) a second cylindrical upper connecting rod orifice partially closed at the bottom by a lower support ring,
a lower connecting rod provided with (a) a lower connecting rod upper face (b) a lower connecting rod lower face, (c) a lower connecting rod journal, which extends upwards from said lower connecting rod upper face, and (d) a caster axle housing, which opens into said lower connecting rod lower face,
an upper end piece comprising a lower journal and an upper journal separated by an upper end piece ring, which lower journal is intended to penetrate into said first cylindrical upper connecting rod orifice, with the interposition of a first bearing structure between the top of said upper bearing ring and the bottom of said upper end piece ring, a second bearing structure being arranged in said first cylindrical upper connecting rod orifice bearing on the bottom of said upper bearing ring, and removable locking means being provided on the side of the upper connecting rod lower face to assemble said upper end piece with said upper connecting rod,
said upper pin being intended to enter a complementary receiving housing provided at the end of a support tab secured to one of said free lateral sides of the screen,
said lower connecting rod journal being intended to penetrate into said second cylindrical upper connecting rod orifice with the interposition of a third bearing structure between the underside of said lower bearing ring and the lower connecting rod upper face a fourth bearing structure being arranged in said second cylindrical upper connecting rod orifice, bearing on the top of said lower bearing ring and removable locking means being provided on the side of the upper connecting rod upper face for assembling said lower connecting rod journal with said upper connecting rod,
said caster axle housing of said lower connecting rod being intended to receive a caster journal secured to the associated caster.

4. Screen made of radioprotective material according to claim 1, wherein the two axes of the connecting rod or rods are spaced apart by a distance of between 30 and 100 mm.

5. Screen made of radioprotective material according to claim 1 wherein said support device of said lateral casters comprises two horizontal connecting rods articulated together around a vertical pivot axis, for the pivoting mounting of said lateral casters around three vertical axes,
wherein the two axes of an upper connecting rod are spaced apart by a distance of between 50 and 80 mm, and wherein the two axes of a lower connecting rod are spaced apart by a distance of between 30 and 50 mm.

6. Screen made of radioprotective material according to claim 1, wherein said support device comprises a support tab which is fixed on one of said free lateral sides by means of fixing screws.

7. Screen made of radioprotective material according to claim 6, wherein said support tab extends in the plane of the wall which it extends.

8. Screen made of radioprotective material according to claim 1, wherein said lateral rollers are provided with removable locking means adapted to ensure that they are maintained in a determined orientation.
